(19) United States
(12) Patent Application Publication
(10) Pub. No.: US 2018/0038389 A1
(43) Pub. Date: Feb. 8, 2018

(54) COMPRESSOR SYSTEM, AND ATTACHMENT STRUCTURE FOR CENTRIFUGAL SEPARATOR

(71) Applicant: MITSUBISHI HEAVY INDUSTRIES, LTD., Tokyo (JP)

(72) Inventor: Akihiro NAKANIWA, Tokyo (JP)

(73) Assignee: MITSUBISHI HEAVY INDUSTRIES, LTD., Tokyo (JP)

(21) Appl. No.: 15/524,730

(22) PCT Filed: Nov. 11, 2015
(86) PCT No.: PCT/JP2015/081761

§ 371 Date: May 5, 2017

(30) Foreign Application Priority Data
Mar. 20, 2015 (JP) 2015-058367
Mar. 20, 2015 (JP) 2015-058368
Mar. 20, 2015 (JP) 2015-058681

(51) Int. Cl. F04D 29/70; B04B 11/02; B04B 5/12; B04B 5/10; F04D 29/42; B01D 45/16

(52) U.S. Cl. CPC F04D 29/701; F04D 29/4206; B01D 45/16; B04B 5/12; B04B 5/10; B04B 11/02; F04D 17/10

(57) ABSTRACT

Provided is a compressor system including: a first impeller of a compressor for pressure-feeding a fluid radially outward after the fluid has flowed in from an axial direction; a centrifugal separator for feeding externally supplied fluid out toward the first impeller while causing the fluid to swirl; and a casing for sectioning off an inflow channel which guides the fluid from the exterior to the centrifugal separator, a first accommodation space which is disposed downstream from the inflow channel and which accommodates the centrifugal separator, a second accommodation space which is connected to the downstream side of the first accommodation space and which accommodates the first impeller, and a foreign substance expulsion channel which expels foreign substances guided to the outer peripheral side by the centrifugal separator.

### TECHNICAL FIELD

The present invention relates to a compressor system and an attachment structure for a centrifugal separator.

The present application claims priority rights concerning Japanese Unexamined Patent Application 2015-058367, submitted on Mar. 20, 2015; Japanese Unexamined Patent Application 2015-058368, submitted on Mar. 20, 2015; and Japanese Unexamined Patent Application 2015-058681, submitted on Mar. 20, 2015; and contents thereof are incorporated herein by reference.

### BACKGROUND ART

A compressor system (motor compressor) wherein a motor and a compressor are in one body has a compressor for compressing gases such as air and gas, and a motor for driving the compressor. A compressor system (motor compressor) has a rotation shaft extending from the casing of the compressor connected with a rotation shaft of the motor, which similarly extends from the motor casing. The rotation of the motor is transmitted to the compressor. The rotation shaft of the motor and compressor rotate stably because they are supported by a plurality of bearings.

For example, such a compressor system (motor compressor) is used in a Subsea Production System as in Non-patent Document 1, or a Floating Production Storage and Offloading facility (FPSO) as in Non-patent Document 2. When used in the subsea production system, the compressor system (motor compressor) is disposed on a sea bed, and feeds out a production fluid, which is a mixture of crude oil, natural gas, and the like, to the sea surface from a production well drilled to a depth of several thousand meters below the sea bed. When used in a floating production storage and offloading facility, the compressor system (motor compressor) is disposed on the sea surface facility, such as a ship.

### CITATION LIST

### Non-Patent Documents

Non-patent document 1: Mitsubishi Industrial Report Vol. 34 No. 5
Non-patent document 2: Turbomachinery International September/October 2014

### SUMMARY OF INVENTION

### Technical Problem

However, with a conventional compressor system, the production fluid, which is a mixture of crude oil, natural gas, and the like, is supplied to the compressor after the gas and liquid have been separated. As such, a centrifugal pump is provided on the upstream side of the compressor for separating gas and liquid. However, when using a centrifugal pump, there is a possibility of the water head decreasing and the function of the pump declining if cavitation occurs. There is room for improvement concerning this point.

If the function of the pump declines and the gas-liquid separation becomes insufficient, fluid is introduced to the compressor with liquid (a foreign substance) mixed therein. Because of this, there have been problems in the impeller of the compressor being damaged.

Such a centrifugal pump is provided on the upstream side of the compressor. With a centrifugal pump, there are many foreign substances included in the introduced fluid. Because of this, centrifugal pumps wear quickly, and the frequency of exchange increases. A conventional centrifugal pump is commonly fixed via a bolt fastener. However, improvement in work efficiency is desired, as it is attachment and removal work via bolts in a limited space. There is room for improvement concerning this point.

When the yield strength of the bolt is insufficient relative to the centrifugal pump which generates a large centrifugal force, there is a risk of the centrifugal pump not being able to maintain a stable state.

With the foregoing in view, a first object of the present invention is to provide a compressor system which, by efficiently separating foreign substances within a fluid, can mitigate mixture of foreign substances into an impeller and prevent damage to an impeller.

With the foregoing in view, a second object of the present is to provide an attachment structure for a centrifugal separator which can improve work efficiency while improving the resistance against the centrifugal force, by performing the attachment and removal work in a simple manner.

### Solution to Problem

To accomplish the first object, a compressor system of a first mode of the present invention is composed of a drive part, an impeller for pressure-feeding a fluid radially outward after the fluid has flowed in from an axial direction by rotating around the shaft line via the drive part, a centrifugal separator provided on the upstream side of the impeller and formed to be larger than the outer diameter of the inlet of the impeller, which feeds the externally supplied fluid out toward the impeller while causing the fluid to swirl by rotating around the shaft line via the drive part, and a casing for sectioning off an inflow channel which guides the fluid from the exterior to the centrifugal separator, a first accommodation space which is disposed downstream from the inflow channel and which accommodates the centrifugal separator, a second accommodation space which is connected to the downstream side of the first accommodation space and which accommodates the impeller, and a foreign substance expulsion channel which is connected downstream of the first accommodation space in the axial direction and expels foreign substances guided to the outer peripheral side by the centrifugal separator.

Such a configuration allows the fluid externally supplied via the inlet channel to the first accommodation space to be accommodated in the first accommodation space and swirled by the centrifugal separator, which rotates around the shaft line via the drive part. The swirled fluid is fed out toward the impeller, which is disposed on the downstream side of the centrifugal separator. At this time, in the first accommodation space, foreign substances with large mass in the fluid are guided radially outward by the centrifugal force which is generated by the centrifugal separator. The foreign substances in the fluid which are guided axially and radially outward by the centrifugal separator are expelled by flowing into a foreign substance expulsion channel, which is connected on the downstream side of the first accommodation space. In other words, the centrifugal separator has a larger diameter than the inlet of the impeller, and the foreign substance expulsion channel is connected at the step portion of the outlet outer diameter of the centrifugal separator and the inlet outer diameter of the impeller. Because of this, the foreign substances which are fed out radially outward flow into the foreign substance expulsion channel and are collected.

Other fluid with lower mass than the foreign substance which flows into the foreign substance expulsion channel is fed out in the axial direction, flows into the impeller which is on the downstream side of the centrifugal separator, and is pressure-fed radially outward by the rotation of the impeller. Because of this, foreign substances contained in the fluid are separated upstream of the impeller. This allows for the mitigation of foreign substances mixing into the impeller, and can prevent damage to the impeller.

In this manner, the foreign object expulsion channel is connected on the outside in the radial direction on the downstream side of the centrifugal separator. As a result, foreign substances guided radially outward by centrifugal force can be efficiently collected. Because of this, when, for example, a liquid is mixed in a fluid which is mainly a gas, the liquid can be guided radially outward by the centrifugal force of the centrifugal separator and collected by the foreign substance expulsion channel. This imparts the function of gas-liquid separation.

In the compressor system of a second mode of the present invention, the foreign object expulsion channel of the first mode preferably extends from the first accommodation space toward the impeller side in the axial direction and radially outward.

Such a configuration makes for a shape which has the direction of the channel of the inflow portion of the foreign substance expulsion channel matches the direction of the flow of the foreign substance guided by the centrifugal force of the centrifugal separator. Because of this, the foreign substance can be made to efficiently flow into the foreign substance expulsion channel.

In the compressor system of a third mode of the present invention, the casing of the first or second mode preferably sections off a foreign substance collection chamber which is connected to the foreign substance expulsion channel.

Such a configuration allows the foreign substances flowing into the foreign substance expulsion channel to be gathered and collected in the foreign substance collection chamber, which is sectioned off by the casing.

In the compressor system of a fourth mode of the present invention, the diameter of the channel cross section of the foreign substance expulsion channel of any one of the first to third modes progressively gets smaller from the upstream side to the downstream side.

Such a configuration allows for an increased flow speed of the fluid (foreign substance) passing through the foreign substance expulsion channel, thereby reducing the pressure; this mitigates damage done to the casing by the pressure of the foreign substance passing through the foreign substance expulsion channel.

To accomplish the first object, the compressor system of a fifth mode of the present invention is composed of a drive part, an impeller for pressure-feeding a fluid radially outward after the fluid has flowed in from an axial direction by rotating around the shaft line via the drive part, a centrifugal separator provided on the upstream side of the impeller, which feeds the externally supplied fluid out toward the impeller while causing the fluid to swirl by rotating around the shaft line via the drive part, and a casing for sectioning off an inflow channel which guides the fluid from the exterior to the centrifugal separator, a first accommodation space which is disposed downstream from the inflow channel and which accommodates the centrifugal separator, a second accommodation space which is connected to the downstream side of the first accommodation space and which accommodates the impeller, and a foreign substance expulsion channel which is connected downstream of the first accommodation space in the axial direction and expels foreign substances guided to the outer peripheral side by the centrifugal separator.

Such a configuration allows the fluid externally supplied via the inlet channel to the first accommodation space to be accommodated in the first accommodation space and swirled by the centrifugal separator, which rotates around the shaft line via the drive part. The swirled fluid is fed out toward the impeller, which is disposed on the downstream side of the centrifugal separator. At this time, in the first accommodation space, foreign substances with large mass in the fluid are guided radially outward by the centrifugal force which is generated by the centrifugal separator. The foreign substance in the fluid which is guided radially outward by the centrifugal separator flows into the foreign substance expulsion channel which extends radially outward from the first accommodation space, and is expelled and collected.

Other fluid with lower mass than the foreign substance which flows into the foreign substance expulsion channel is fed out in the axial direction, flows into the impeller which is on the downstream side of the centrifugal separator, and is pressure-fed radially outward by the rotation of the impeller. Because of this, foreign substances contained in the fluid are separated upstream of the impeller. This allows for the mitigation of foreign substances mixing into the impeller, and can prevent damage to the impeller.

In this manner, the present invention is a configuration such that the foreign substance expulsion channel is connected so it extends outward in the radial direction of the first accommodation space. The foreign substance expulsion channel is a smooth channel along the axial direction and is formed so that there is no ridge or the like in the first accommodation space and at the connection portion between the first accommodation space and the second accommodation space. This inhibits the occurrence of turbulent flow, and allows the foreign substances guided radially outward by centrifugal force to be efficiently collected. Because of this, when, for example, a liquid is mixed in a fluid which is mainly a gas, the liquid can be guided radially outward by the centrifugal force of the centrifugal separator and collected by the foreign substance expulsion channel. This imparts the function of gas-liquid separation.

In the compressor system of a sixth mode of the present invention, the casing of the fifth mode preferably sections off a foreign substance collection chamber which connects to the foreign substance expulsion channel and extends over the entire periphery along the circumferential direction around the shaft line.

Such a configuration allows the foreign substance flowing into a plurality of foreign substance expulsion channels to be gathered and collected in one foreign substance collection chamber which extends over the entire periphery of the circumferential direction and is sectioned off by the casing.

In the compressor system of a seventh mode of the present invention, a plurality of the foreign substance expulsion channel of the fifth or sixth mode is provided in the circumferential direction around the shaft line. These foreign substance expulsion channels are preferably disposed in a pressure region which causes the pressure of the fluid in the circumferential direction of the first accommodation space to be equal.

According to such a configuration, fluid (foreign substance) at an equal pressure can flow into the plurality of foreign substance expulsion channels disposed along the circumferential direction, thereby allowing the pressure balance of the fluid in the first accommodation space to be stabilized, and the foreign substance flowing into the foreign substance expulsion channel can be prevented from returning to the first accommodation space.

In the compressor system of an eighth mode of the present invention, a plurality of the foreign substance expulsion channel of any one of the fifth to the seventh modes is preferably provided along the axial direction of the first accommodation space.

In this case, the fluid (foreign substance) guided radially outward by the centrifugal force of the centrifugal separator can be gradually collected via the foreign substance expulsion channels in a plurality of locations along the axial direction of the first accommodation space. This improves the gas-liquid separation function.

To accomplish the second objective, the attachment structure for a centrifugal separator of a ninth mode of the present invention is an attachment structure for a centrifugal separator which is provided on the upstream side of an impeller which pressure-feeds a fluid radially outward after the fluid has flowed in from an axial direction by rotating around the shaft line via the drive part, and feeds the externally supplied fluid out toward the impeller while causing the fluid to swirl by rotating around a rotation shaft on the same shaft as the shaft line via the drive part, wherein the centrifugal separator has two protruding parts provided thereon which protrude toward both sides in the axial direction from a base part of the rotation shaft side, a first protruding part, of the two protruding parts, is pressed from the outer peripheral side by a holding recessed part provided on a holding part provided as one body on the rotation shaft, and a second protruding part, which is pressed from the outer peripheral side by a fitting member which can be attached and removed relative to the rotation shaft.

According to such a configuration, the centrifugal separator is attached to the rotation shaft in a state that protruding parts protruding on both sides of the axial direction from the base thereof are pressed from the outer peripheral side by a holding part and a fitting member. In other words, the base of the centrifugal separator is pressed in the direction opposite the centrifugal force which acts radially outward. As a result, resistance against centrifugal force can be increased. Furthermore, for example, in a case where the holding part provided as one body on the rotation shaft is the rotor of the drive part, one first protruding part is pressed on its entire periphery by the rotor, thereby securing stability and high strength.

The fitting member which presses the other second protruding part from the outer peripheral side is attachable and removable relative to the rotation shaft. Thus, by freeing the fitting of the fitting member relative to the rotation shaft, the press on the second protruding part can be released, and the centrifugal separator can easily be removed from the rotation shaft.

This makes it possible to improve the work efficiency when attaching and removing the centrifugal separator. Because of this, there is the advantage of being able to efficiently exchange or perform maintenance such as cleaning for the centrifugal separator.

In the attachment structure for a centrifugal separator of a tenth mode of the present invention, the fitting member is provided on the same shaft as the rotation shaft, and is provided with a female screw which screws into the outer peripheral surface of the rotation shaft, and a fitting recessed part, which fits from the outer peripheral side relative to the second protruding part.

In this case, when detaching the centrifugal separator from the rotation shaft, the screw attachment relative to the rotation shaft is freed by rotating the nut-style fitting member in the direction that the screw loosens. This allows the pressing of the fitting recessed part relative to the second protruding part to be released.

In the attachment structure for a centrifugal separator of an eleventh mode of the present invention, the centrifugal separator of the ninth or tenth mode may be divided in the circumferential direction.

In this case, the centrifugal separator, which is divided in the circumferential direction, can be detached from the rotation shaft by simply freeing the fitting of the fitting member relative to the second protruding part. In other words, the centrifugal separator can be exchanged without performing work to free the rotor connected to the rotation shaft from the rotation shaft. In particular, in the case that the fitting member is of the nut-style described above, the work of completely detaching the fitting member from the rotation shaft becomes unnecessary.

### Advantageous Effects of Invention

According to the compressor system of the present invention, by efficiently separating foreign substances within a fluid, it is possible to mitigate mixture of foreign substances into an impeller and prevent damage to an impeller.

According to the attachment structure for a centrifugal separator of the present invention, work efficiency can be improved while improving the resistance against the centrifugal force, by performing the attachment and removal work in a simple manner.

### BRIEF DESCRIPTION OF DRAWINGS

FIG. 1 is a schematic view for describing the compressor system of an embodiment of the present invention.

FIG. 2 is a vertical cross section view illustrating details of the compressor and centrifugal separator illustrated in FIG. 1 of the first embodiment of the present invention; and is a drawing such that the left and right of FIG. 1 have been switched.

FIG. 3 is an expanded view of important parts of the centrifugal separator illustrated in FIG. 2.

FIG. 4 is a vertical cross-sectional view illustrating details of the compressor and centrifugal separator illustrated in FIG. 1 of a second embodiment of the present invention; and is a drawing such that the left and right of FIG. 1 have been switched.

FIG. 5 is an expanded view illustrating important parts of a casing which surrounds the centrifugal separator of FIG. 4.

FIG. 6 is a drawing illustrating a first accommodation space, which is a cross-sectional view at line A-A illustrated in FIG. 5.

FIG. 7 is a drawing illustrating a first accommodation space according to a first modification, and is a drawing which corresponds to FIG. 6.

FIG. 8 is a vertical cross-sectional view illustrating a casing which surrounds a centrifugal separator according to a second modification, and is a drawing which corresponds to FIG. 5.

FIG. 9 is a vertical cross-sectional view illustrating details of the compressor and centrifugal separator illustrated in FIG. 1 of a third embodiment of the present invention; and is a drawing such that the left and right of FIG. 1 have been switched.

FIG. 10 is an expanded view of important parts of the centrifugal separator illustrated in FIG. 9.

### DESCRIPTION OF EMBODIMENTS

### First Embodiment

The compressor system according to embodiments of the present invention is described below, with reference to the drawings. These embodiments illustrate one mode of the present invention, do not limit the present invention, and may be arbitrarily changed within a range of technical thought of the present invention.

A compressor system 1 is provided on a sea bed used in a Subsea Production System, which is a development style of an ocean oil-gas field, on the sea used in a Floating Production Storage and Offloading (FPSO) facility, and the like. The compressor system 1 pressure-feeds, as an operating fluid, a production fluid such as oil and gas retrieved from a production well of an oil-gas field existing from several hundred to several thousand meters below the sea bed.

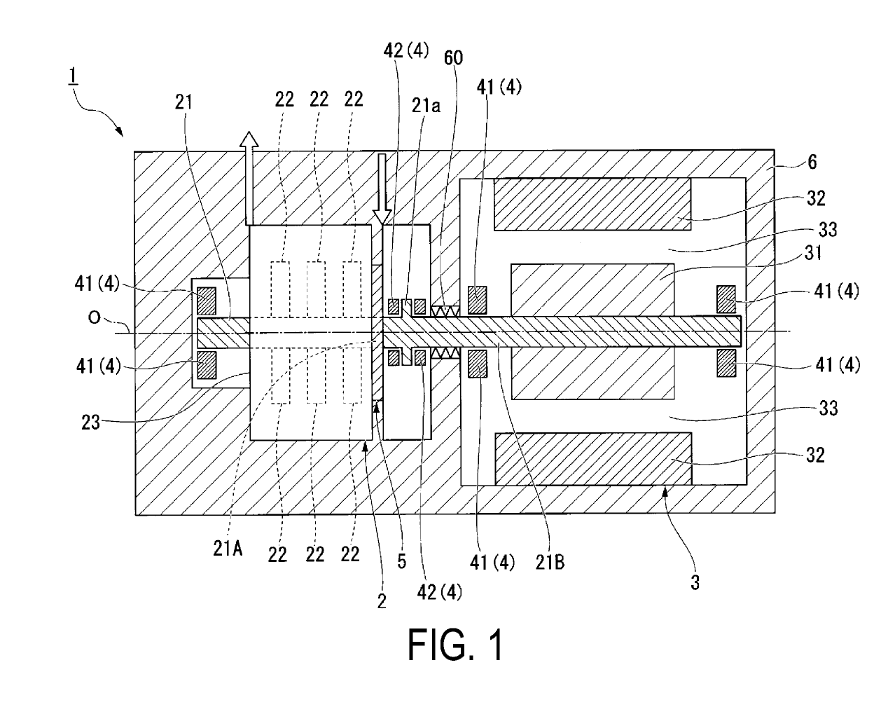

The compressor system 1 is provided with a compressor 2, a motor 3 (drive part), a bearing 4 (drive part), a centrifugal separator 5, and a casing 6, as illustrated in FIG. 1. The compressor 2 has a shaft 21 as a rotation shaft, which extends in the direction of an axis O (the left-right direction in FIG. 1). The motor 3 has a rotor 31 which is directly connected to the shaft 21. The bearing 4 supports the shaft 21. The centrifugal separator 5 is provided on the upstream side of a first impeller 22 of the compressor 2. The casing 6 accommodates the motor 3, the compressor 2, and the centrifugal separator 5.

The compressor 2 is accommodated in the casing 6. The compressor 2 compresses an operating fluid via the rotor 31 and the shaft 21, which rotate around the axis O. The compressor 2 of the present embodiment has the shaft 21, the first impeller 22, and a housing 23. The shaft 21 extends in the direction of the axis O. The first impeller 22 is fixed on the outer peripheral surface of the shaft 21. The housing 23 accommodates the first impeller 22.

The shaft 21 is a rotation shaft which extends in the direction of the axis O. The shaft 21 is supported by the casing 6 such that it is rotatable around the axis O. The shaft 21 penetrates the housing 23. Both ends of the shaft 21 extend out from the housing 23. The shaft 21 extends in the direction of the axis O in the casing 6, which is described hereinafter.

The first impeller 22 rotates around the axis O with the shaft 21, and generates compressed fluid by compressing the operating fluid which passes through the interior of the first impeller 22. In other words, the first impeller 22 pressure-feeds the operating fluid flowing in from the direction of the axis O radially outward.

The housing 23 is the exterior of the compressor 2. The housing 23 accommodates the first impeller 22 in its interior. The housing 23 is accommodated in the casing 6.

The motor 3 is accommodated in the casing 6 with an open interval in the direction of the axis O relative to the compressor 2. The motor 3 has the rotor 31 and a stator 32. The rotor 31 is fixed so it is in one body with the shaft 21. The stator 32 is disposed on the outer peripheral side of the rotor 31.

The rotor 31 is rotatable around the axis O and is in one body with the shaft 21. The rotor 31 is directly connected to the outer peripheral side of the shaft 21, which is the outer side of the circumferential direction where the axis O is the reference, such that it rotates as one body with the shaft 21 of the compressor 2 without going through a gear or the like. The rotor 31 has, for example, a rotor core (not illustrated) through which induced current flows as the stator 32 generates a rotating magnetic field.

The stator 32 is provided covering the rotor 31 from the outer peripheral side with a gap 33 open in the circumferential direction. The stator 32 has, for example, a plurality of stator cores (not illustrated) disposed along the circumferential direction of the rotor 31, and a stator winding (not illustrated) wound on the stator core. The stator 32 generates a rotating magnetic field as current flows from the exterior, thereby rotating the rotor 31. The stator 32 is fixed in the casing 6.

The bearing 4 is accommodated in the casing 6. The bearing 4 rotatably supports the shaft 21. The bearing 4 of the present embodiment is provided with a plurality of journal bearings 41 and a thrust bearing 42.

The journal bearings 41 support a load which acts in the radial direction relative to the shaft 21, with the axis O as the reference. The journal bearings 41 are disposed on both ends in the direction of the axis O of the shaft 21 so as to sandwich the motor 3 and the compressor 2 from the direction of the axis O. The journal bearings 41 are disposed between the region in which the compressor 2 is provided and the region in which the motor 3 is provided, closer to the motor 3 than a seal member 60, described hereinafter.

The thrust bearing 42 supports the load acting on the shaft 21 in the direction of the axis O via a thrust collar 21a formed on the shaft 21. The thrust bearing 42 is disposed between the region in which the compressor 2 is provided and the region in which the motor 3 is provided, closer to the compressor 2 than the seal member 60, described hereinafter.

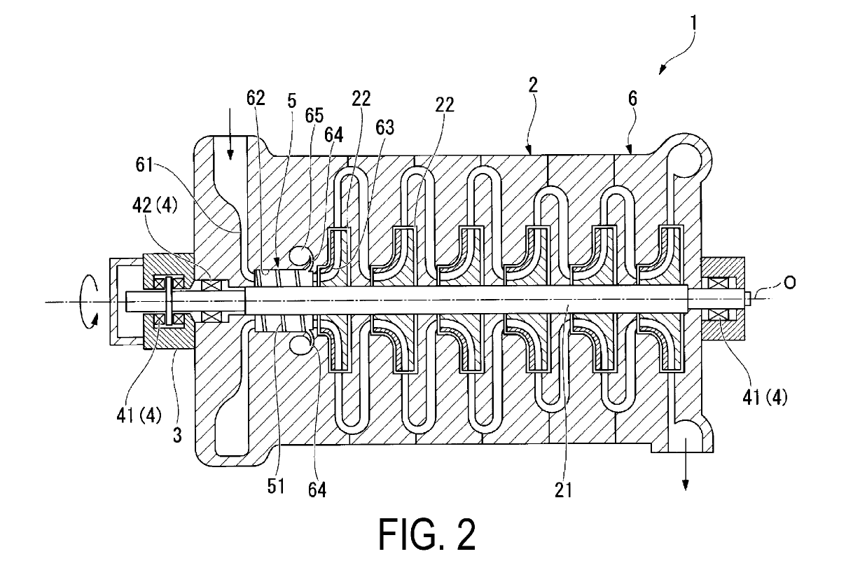

The centrifugal separator 5 is provided on the upstream side of the compressor 2, as illustrated in FIG. 2. The centrifugal separator 5 is formed to be larger than the outer diameter of the inlet of the first impeller 22 of the compressor 2. The centrifugal separator 5 rotates with the motor 3 around the axis O via the shaft 21. As a result, the centrifugal separator 5 has a configuration which feeds out the externally supplied operating fluid toward the first impeller 22 while swirling it.

The centrifugal separator 5 is provided as a separate body from the first impeller 22 of the compressor 2. The centrifugal separator 5 is accommodated in the casing 6. The centrifugal separator 5 is a separator provided with a second impeller 51 fixed on the outer peripheral surface of the shaft 21 of the compressor 2, which extends in the direction of the axis O. The radius r1 of the second impeller 51 of the centrifugal separator 5 is set to be a larger dimension than the radius r2 of the inlet of the first impeller 22 of the compressor 2 (r1>r2).

Note that the rotation shaft of the centrifugal separator 5 is shared with the shaft 21 of the compressor 2, but it may be provided as a separate body.

The second impeller 51 rotates around the axis O with the shaft 21. The second impeller 51 pressure-feeds an operating fluid, which flows in from the direction of the axis O and passes through the interior of the second impeller 51, toward the direction of the axis O as well as radially outward, by centrifugal force.

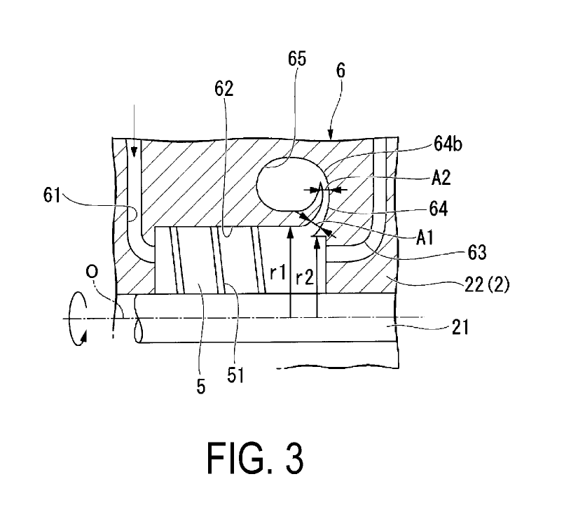

The casing 6 forms a cylindrical shape along the axis O, as illustrated in FIG. 3. The casing 6 accommodates the compressor 2, the motor 3, and the centrifugal separator 5 in its interior. The inner surface of the casing 6 protrudes toward the shaft 21 between the compressor 2 and the motor 3 in the direction of the axis O. The protruding portion of the casing 6 is provided with a seal member 60 which makes a seal between the region in which the compressor 2 is provided, the region in which the centrifugal separator 5 is provided, and the region in which the motor 3 is provided.

The casing 6 sections off an inflow channel 61, a first accommodation space 62, a second accommodation space 63, a foreign substance expulsion channel 64, and a foreign substance collection chamber 65. The inflow channel 61 guides the operating fluid from the exterior to the centrifugal separator 5. The first accommodation space 62 is disposed on the downstream side of the inlet channel 61 and accommodates the centrifugal separator 5. The second accommodation space 63 is connected on the downstream side of the first accommodation space 62, and accommodates the first impeller 22 of the compressor 2. The foreign substance expulsion channel 64 is connected in the direction of the axis O on the downstream side of the first accommodation space 62 and expels foreign substances in the operating fluid guided toward the outer peripheral side by the centrifugal separator 5. The foreign substance collection chamber 65 is connected to the foreign substance expulsion channel 64.

The first accommodation space 62 connects with the inflow channel 61 on one end side. The first accommodation space 62 connects with the second accommodation space 63 and the foreign substance expulsion channel 64 on the other end side. The first accommodation space 62 takes in the external operating fluid from the inflow channel 61. The first accommodation space 62 is an interior space formed in the casing 6 so as to rotatably accommodate the second impeller 51 of the centrifugal separator 5.

The foreign substance expulsion channel 64 extends from the first accommodation space 62 toward the side of the compressor 2 in the axial direction as well as radially outward. As for the foreign substance expulsion channel 64, the diameter of the channel cross section of the foreign substance expulsion channel 64 progressively gets smaller from the upstream side to the downstream side. That is, the upstream side cross section A1 on the first accommodation space 62 side of the foreign substance expulsion channel 64 illustrated in FIG. 3 is larger than the downstream side cross section A2 positioned on the foreign substance collection chamber 65 side. As illustrated in FIG. 2, the foreign substance expulsion channel 64 is disposed as a plurality in the circumferential direction around the axis O (on the surface of the paper, two locations above and below).

The foreign substance collection chamber 65 is formed in the casing 6. The foreign substance collection chamber 65 extends over the entire periphery along the circumferential direction around the axis O. The foreign substance collection chamber 65 connects to the downstream side end part (an outlet 64b) of the foreign substance expulsion channel 64.

The operation of the compressor system 1 of the configuration described above is described next in detail, with reference to the drawings.

As illustrated in FIG. 1, according to the compressor system 1 such as that described above, the stator 32 is supplied with electric current via an external device such as an electric generator, which is not illustrated. A rotating magnetic field is generated based on the supplied electric current, and the rotor 31 of the motor 3 starts to rotate with the shaft 21. As the shaft 21 rotates with high speed, as illustrated in FIG. 3, operating fluid is supplied from the exterior via the inflow channel 61 to the first accommodation space 62. The operating fluid is accommodated in the first accommodation space 62 and swirled by the centrifugal separator 5, which rotates around the axis O via the motor 3. The swirled operating fluid is fed out toward the first impeller 22 of the compressor 2 disposed on the downstream side of the centrifugal separator 5. At this time, in the first accommodation space 62, foreign substances with large mass in the operating fluid are guided radially outward by the centrifugal force which is generated by the centrifugal separator 5.

The foreign substance of the operating fluid, which has been guided toward the axial direction and radially outward by the centrifugal separator 5, flows into the foreign substance expulsion channel 64 which is connected on the downstream side of the centrifugal separator 5 and is expelled. The centrifugal separator 5 has a larger diameter than the inlet of the first impeller 22, and the foreign substance expulsion channel 64 is connected at the ridge portion of the outlet outer diameter of the centrifugal separator 5 and the impeller inlet outer diameter of the compressor 2. This causes the foreign substance fed out along the outside in the radial direction to flow into the foreign substance expulsion channel 64 and be collected in the foreign substance collection chamber 65.

The other operating fluid, which has smaller mass than the foreign substance which has flowed into the foreign substance expulsion channel 64 is fed out in the axial direction and is made to flow into the first impeller 22 of the compressor 2, which is on the downstream side of the first accommodation space 62, and is then pressure-fed radially outward by the rotation of the first impeller 22. This causes the foreign substance contained in the operating fluid to be separated on the upstream side of the first impeller 22. Thus, it becomes possible to mitigate the mixing of foreign substance into the first impeller 22, and prevent damage to the first impeller 22.

In this manner, in the first embodiment, the foreign substance expulsion channel 64 is connected on the downstream side and on the outer side in the radial direction of the centrifugal separator 5. As a result, the foreign substance which is guided radially outward by centrifugal force can be efficiently collected. Because of this, when, for example, a liquid is mixed in a fluid which is mainly a gas, the liquid can be guided radially outward by the centrifugal force of the centrifugal separator 5 and collected by the foreign substance expulsion channel 64. This imparts the function of gas-liquid separation. Thus, when the operating fluid is a production fluid, which is a mix of crude oil, natural gas, and the like retrieved by a subsea production system as in the first embodiment, gas-liquid separation can be done efficiently, and a superior effect can be exhibited.

In the first embodiment, as illustrated in FIG. 3, the foreign substance expulsion channel 64 extends from the first accommodation space 62 on the first impeller 22 side in the axial direction, and radially outward. This makes for a shape which has the direction of the channel of the inflow portion of the foreign substance expulsion channel 64 match the direction of the flow of the foreign substance guided by the centrifugal force of the centrifugal separator 5. This allows the foreign substance to efficiently flow into the foreign substance expulsion channel 64.

In the first embodiment, a foreign substance collection chamber 65 which connects to the foreign substance expulsion channel 64 is sectioned off by the casing 6. This allows the foreign substance that has flowed into the foreign substance expulsion channel 64 to be gathered and collected in the foreign substance collection chamber sectioned off by the casing 6.

The diameter of the channel cross section of the foreign substance expulsion channel 64 progressively gets smaller from the upstream side to the downstream side. This increases the flow speed of the operating fluid (foreign substance) passing through the foreign substance expulsion channel 64, allowing the pressure to be reduced. This allows the mitigation of damage to the casing 6 from the pressure of the foreign substance passing through the foreign substance expulsion channel 64.

The compressor system according to the first embodiment described above makes it possible to mitigate the mixing of foreign substance into the first impeller 22 of the compressor 2, and to prevent damage to the first impeller 22, by efficiently separating the foreign substance in the operating fluid.

An embodiment of the compressor system according to the present invention has been described but the present invention is not limited to the aforementioned first embodiment, and may be changed as appropriate in a range that does not deviate from the main intent thereof.

For example, in the first embodiment, a plurality of the foreign substance expulsion channel 64 is disposed in the circumferential direction (for example, in FIG. 2, in two locations above and below); the number of locations installed may be appropriately set, and may be only one location.

### Second Embodiment

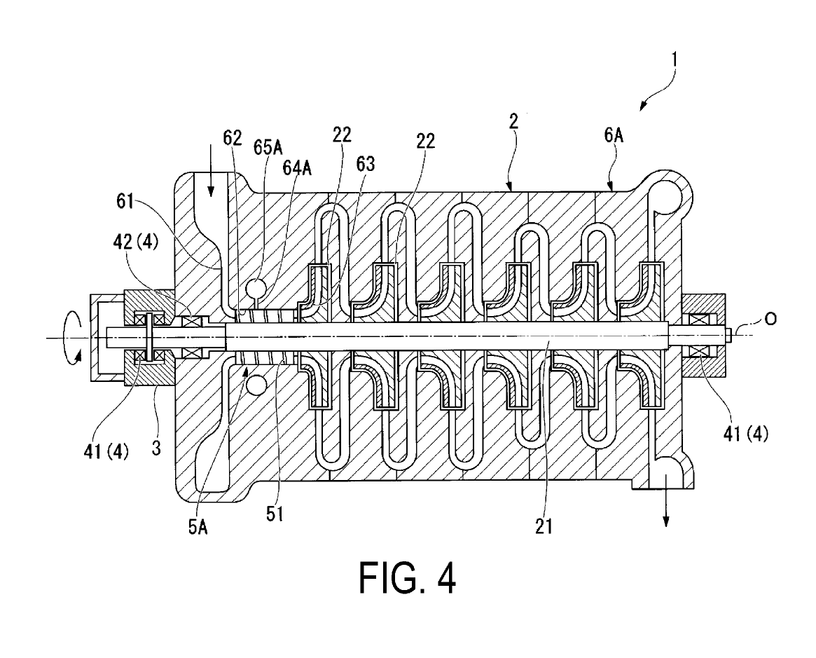

The compressor system of the second embodiment is described next, with reference to FIG. 4 to FIG. 8.

Constituent elements of the second embodiment which are equivalent to the first embodiment are given the same symbol and their detailed descriptions are omitted. The compressor system of the second embodiment is partially different from the first embodiment concerning the centrifugal separator.

A centrifugal separator 5A of the second embodiment is provided on the upstream side of the compressor 2 as illustrated in FIG. 4. The centrifugal separator 5A is formed larger than the outer diameter of the inlet of the first impeller 22 of the compressor 2. The centrifugal separator 5A rotates around the axis O with the motor 3 via the shaft 21. This makes the centrifugal separator 5A have a configuration which feeds out the externally supplied operating fluid toward the first impeller 22 while swirling it.

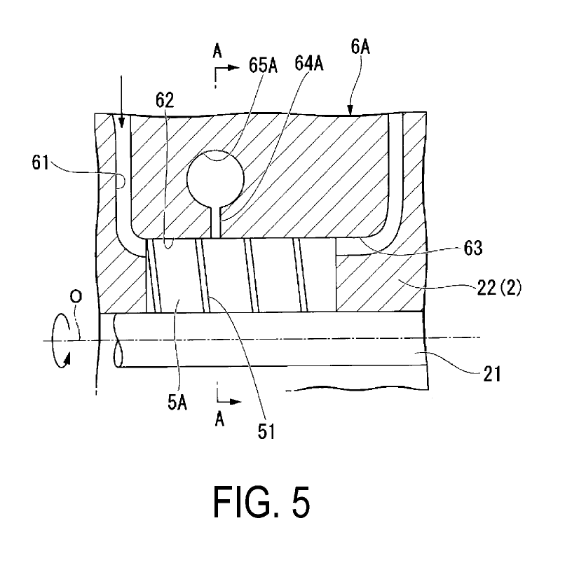

The centrifugal separator 5A is provided as a separate body from the first impeller 22 of the compressor 2, as illustrated in FIG. 5. The centrifugal separator 5A is accommodated in a casing 6A. The centrifugal separator 5A is a separator provided with the second impeller 51 fixed on the outer peripheral surface of the shaft 21 of the compressor 2, which extends in the direction of the axis O.

Note that the rotation shaft of the centrifugal separator 5A is shared with the shaft 21 of the compressor 2, but it may be provided as a separate body.

The second impeller 51 rotates with the shaft 21 around the axis O, and pressure-feeds the operating fluid flowing in from the direction of the axis O and passing through the interior of the second impeller 51 toward the outside of the direction of the axis O and the radial direction by centrifugal force.

The casing 6A forms a cylindrical shape along the axis O, as illustrated in FIG. 5. The casing 6A accommodates the compressor 2, the motor 3, and the centrifugal separator 5A in its interior. The inner surface of the casing 6A protrudes toward the shaft 21 between the compressor 2 and the motor 3 in the direction of the axis O. The protruding portion of the casing 6A is provided with the seal member 60 which makes a seal between the region in which the compressor 2 is provided, the region in which the centrifugal separator 5 is provided, and the region in which the motor 3 is provided.

The casing 6A sections off an inflow channel 61, a first accommodation space 62, a second accommodation space 63, a foreign substance expulsion channel 64A, and a foreign substance collection chamber 65A. The inflow channel 61 guides the operation fluid from the exterior to the centrifugal separator 5A. The first accommodation space 62 is disposed on the downstream side of the inlet channel 61 and accommodates the centrifugal separator 5A. The second accommodation space 63 is connected on the downstream side of the first accommodation space 62, and accommodates the first impeller 22 of the compressor 2. The foreign substance expulsion channel 64A extends radially outward from the first accommodation space 62 and expels the foreign substance in the operating fluid guided to the outer peripheral side by the centrifugal separator 5A. The foreign substance collection chamber 65A is connected to the foreign substance expulsion channel 64A.

The first accommodation space 62 connects on with the inflow channel 61 one end side. The first accommodation space 62 connects with the second accommodation space 63 on the other end side. The first accommodation space 62 takes in the external operating fluid from the inflow channel 61. The first accommodation space 62 is an interior space formed in the casing 6A which rotatably accommodates the second impeller 51 of the centrifugal separator 5A.

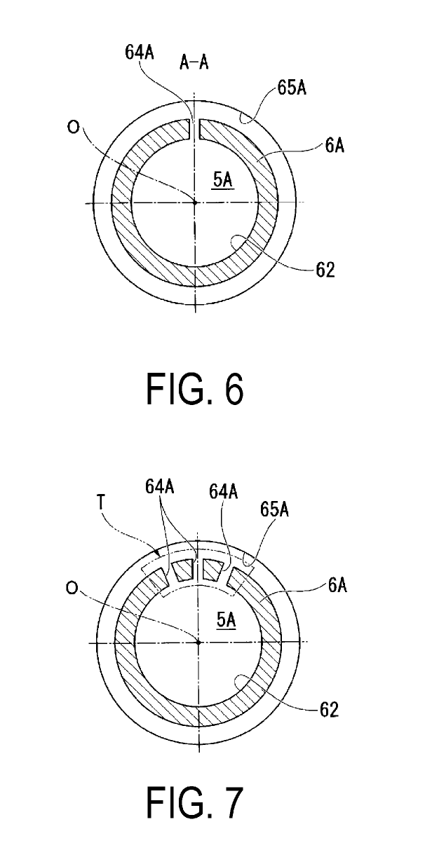

The foreign substance expulsion channel 64A is attached in the central part of the axial direction of the first accommodation space 62. The foreign substance expulsion channel 64A is disposed at one location (the upper side on the paper surface) in the circumferential direction around the axis O, as illustrated in FIG. 6. The foreign substance expulsion channel 64A forms a hole shape, and the channel cross section has the same cross section from its inlet to its outlet.

The foreign substance collection chamber 65A is formed in the casing 6A. The foreign substance collection chamber 65A extends over the entire periphery along the circumferential direction around the axis O. The foreign substance collection chamber 65A connects to the downstream side end part (an outlet 64b) of the foreign substance expulsion channel 64A.

Note that the foreign substance expulsion channel 64A has a configuration such that its entire circumferential direction does not connect to the first accommodation space 62. Because of this, the foreign substance expulsion channel 64A has a configuration which, when the operating fluid which has differing pressure in the circumferential direction flows into the same foreign substance collection chamber 65A, can mitigate the return of the collected operating fluid from the foreign substance collection chamber 65A into the first accommodation space 62 due to the differing pressure.

The operation of the compressor system 1 of the configuration described above is described next in detail, with reference to the drawings.

As illustrated in FIG. 1, according to the compressor system 1 such as that described above, the stator 32 is supplied with electric current via an external device such as an electric generator, which is not illustrated. A rotating magnetic field is generated based on the supplied electric current, and the rotor 31 of the motor 3 starts to rotate with the shaft 21. As the shaft 21 rotates with high speed, as illustrated in FIG. 5, operating fluid is supplied from the exterior via the inflow channel 61 to the first accommodation space 62. The operating fluid is accommodated in the first accommodation space 62 and swirled by the centrifugal separator 5A, which rotates around the axis O via the motor 3. The swirled operating fluid is fed out toward the first impeller 22 of the compressor 2 disposed on the downstream side of the centrifugal separator 5A. At this time, in the first accommodation space 62, foreign substances with large mass in the operating fluid are guided radially outward by the centrifugal force which is generated by the centrifugal separator 5A.

The foreign substance in the operating fluid guided radially outward by the centrifugal separator 5A flows into the foreign substance expulsion channel 64A which extends radially outward from the first accommodation space 62, is expelled, and collected.

The other operating fluid, which has smaller mass than the foreign substance which has flowed into the foreign substance expulsion channel 64A, is fed out in the direction of the axis O and is made to flow into the first impeller 22 of the compressor 2, which is on the downstream side of the centrifugal separator 5A, and is then pressure-fed radially outward by the rotation of the first impeller 22. This causes the foreign substance contained in the operating fluid to be separated on the upstream side of the first impeller 22. Thus, it becomes possible to mitigate the mixing of foreign substance into the first impeller 22, and prevent damage to the first impeller 22.

In this manner, the second embodiment is a configuration such that the foreign substance expulsion channel 64A is connected so it extends outward in the radial direction of the first accommodation space 62. The foreign substance expulsion channel 64A is a smooth channel along the direction of the axis O and is formed so that there is no ridge or the like in the first accommodation space 62, and at the connection portion between the first accommodation space 62 and the second accommodation space 63. This inhibits the occurrence of turbulent flow, and allows the foreign substances guided radially outward by centrifugal force to be efficiently collected. Because of this, when, for example, a liquid is mixed in a fluid which is mainly a gas, the liquid can be guided radially outward by the centrifugal force of the centrifugal separator 5A and collected by the foreign substance expulsion channel 64A. This imparts the function of gas-liquid separation.

Thus, when the operating fluid is a production fluid, which is a mix of crude oil, natural gas, and the like, and is retrieved by a subsea production system as in the first embodiment, gas-liquid separation can be done efficiently, and a superior effect can be exhibited.

In the second embodiment, the configuration has the foreign substance expulsion channel 64A in one location, but the foreign substance collection chamber 65A extend over the entire periphery of the circumferential direction. Because of this, if a plurality of foreign substance expulsion channels 64A are disposed relative to one foreign substance collection chamber 65A, foreign substance expelled from a plurality of locations can be efficiently gathered and collected in one foreign substance collection chamber 65A.

The compressor system according to the second embodiment described above makes it possible to mitigate the mixing of foreign substance into the first impeller 22 of the compressor 2, and to prevent damage to the first impeller 22, by efficiently separating the foreign substance in the operating fluid.

An embodiment of the compressor system according to the present invention has been described but the present invention is not limited to the aforementioned second embodiment, and may be changed as appropriate in a range that does not deviate from the main intent thereof.

For example, in the second embodiment, the configuration was such that the foreign substance expulsion channel 64A was connected in the center part of the first accommodation space 62 in the direction of the axis O, but the connection position in the direction of the axis O is not limited to this. For example, it may be a position near the inlet channel 61 on the upstream side of the first accommodation space 62 in the direction of the axis O, or a position near the second accommodation space 63 on the downstream side.

As in a first modification illustrated in FIG. 7, it may be a configuration such that a plurality (in FIG. 7, three locations in the upper region) of foreign substance expulsion channels 64A are provided in the circumferential direction, where these foreign substance expulsion channels 64A are disposed in a pressure region T (the two-point chain line illustrated in FIG. 7) which makes the pressure of the operating fluid equal in the circumferential direction of the first accommodation space 62.

In this case, fluid (foreign substance) of an equal pressure can be made to flow into the plurality of foreign substance expulsion channels 64A disposed along the circumferential direction. This allows the pressure balance of the operating fluid in the first accommodation space 62 to be stabilized, and can prevent the foreign substance that has flowed into the foreign substance expulsion channel 64A from returning to the first accommodation space 62.

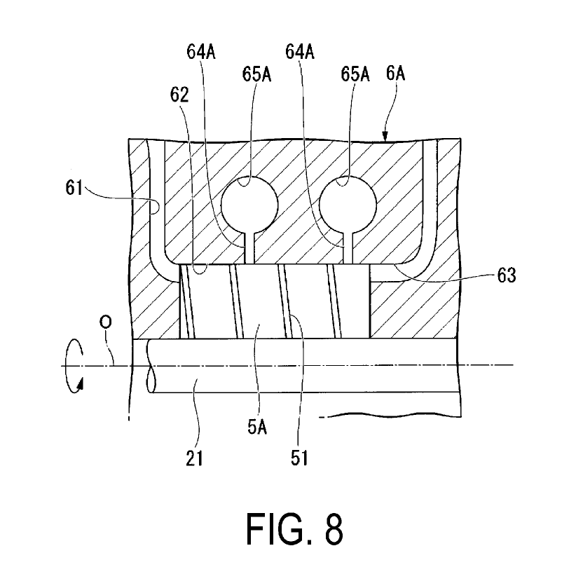

A second modification, which is illustrated in FIG. 8, has a configuration such that in the casing 6A, a plurality (here, two locations) of foreign substance expulsion channels 64A are provided along the direction of the axis O of the first accommodation space 62. A foreign substance collection chamber 65A is provided extending along the circumferential direction relative to each foreign substance expulsion channel 64A.

In this case, the operating fluid (foreign substance) guided radially outward by centrifugal force from the centrifugal separator 5A can be collected gradually by the foreign substance expulsion channels 64A, 64A in two locations along the direction of the axis O of the first accommodation space 62, thereby allowing improvement of the gas-liquid separation function.

Note that in this case, in order to prevent foreign substance expulsion channels 64A, 64A which are next to each other in the direction of the axis O from connecting with each other via the centrifugal separator 5A, the pitch in the direction of the axis O between the foreign substance expulsion channels 64 should be matched to the pitch of the second impeller 51 of the centrifugal separator 5A.

In the first embodiment and the second embodiment, configurations for the shape of the second impeller 51 of the centrifugal separators 5, 5A; the cross-sectional area and extension length of the foreign substance expulsion channels 64, 64A; and the cross-sectional shape of the foreign substance collection chambers 65, 65A and the like may be set as appropriate.

In the first embodiment and the second embodiment, the foreign substance collection chamber 65, 65A had a configuration such that it extended along the entire periphery of the circumferential direction, but it may be provided on one part of the circumferential direction.

### Third Embodiment

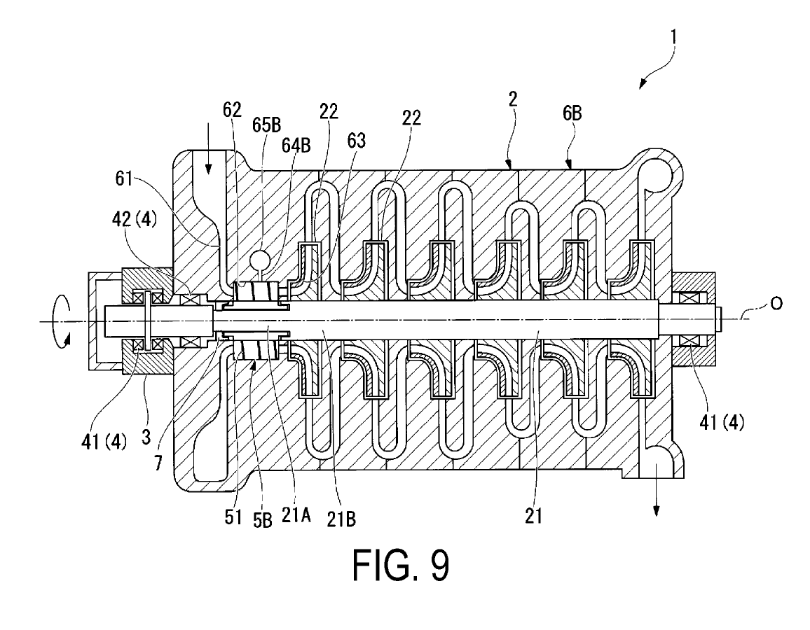

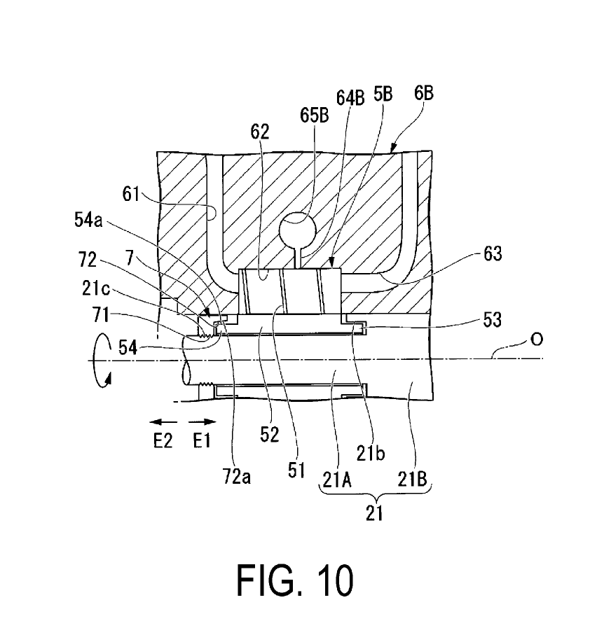

The attachment structure for a centrifugal separator of the third embodiment is described next, with reference to FIGS. 9 and 10.

In the third embodiment, constituent elements which are equivalent to those of the first embodiment and the second embodiment are given the same symbol and their detailed descriptions are omitted. The compressor system of the third embodiment is partially different from the first embodiment concerning the centrifugal separator.

The centrifugal separator 5B of the third embodiment is provided on the upstream side of the compressor 2, as illustrated in FIG. 9. The centrifugal separator 5B is formed larger than the outer diameter of the inlet of the first impeller 22 of the compressor 2. The centrifugal separator 5B rotates around the axis O with the motor 3 via the shaft 21. This makes the centrifugal separator 5B have a configuration which feeds out the externally supplied operating fluid toward the first impeller 22 while swirling it.

As illustrated in FIG. 10, the centrifugal separator 5B is provided as a separate body from the first impeller 22 of the compressor 2. The centrifugal separator 5B is accommodated in a casing 6B. The centrifugal separator 5B is a separator provided with a second impeller 51 fixed on the outer peripheral surface of the shaft 21 of the compressor 2, which extends in the direction of the axis O.

Note that the rotation shaft of the centrifugal separator 5B is shared with the shaft 21 of the compressor 2, but it may be provided as a separate body. Here, as necessary, the portion of the shaft 21 to which the centrifugal separator 5B attaches is called a rotation shaft 21A in the description below.

The second impeller 51 rotates around the axis O with the shaft 21 (rotation shaft 21A), and pressure-feeds the operating fluid, which flows in from the direction of the axis O and passes through the interior of the second impeller 51, in the direction of the axis O and radially outward by centrifugal force.

The casing 6B forms a cylindrical shape along the axis O, as illustrated in FIG. 10. The casing 6B accommodates the compressor 2, the motor 3, and the centrifugal separator 5B in its interior. The inner surface of the casing 6B protrudes toward the shaft 21 between the compressor 2 and the motor 3 in the direction of the axis O. The protruding portion of the casing 6B is provided with the seal member 60 which makes a seal between the region in which the compressor 2 is provided, the region in which the centrifugal separator 5B is provided, and the region in which the motor 3 is provided.

The casing 6B sections off an inflow channel 61, a first accommodation space 62, a second accommodation space 63, a foreign substance expulsion channel 64B, and a foreign substance collection chamber 65B. The inflow channel 61 guides the operating fluid from the exterior to the centrifugal separator 5B. The first accommodation space 62 is disposed on the downstream side of the inlet channel 61 and accommodates the centrifugal separator 5. The second accommodation space 63 is connected on the downstream side of the first accommodation space 62, and accommodates the first impeller 22 of the compressor 2. The foreign substance expulsion channel 64B extends radially outward from the first accommodation space 62 and expels the foreign substance in the operating fluid guided to the outer peripheral side by the centrifugal separator 5B. The foreign substance collection chamber 65B is connected to the foreign substance expulsion channel 64B.

The first accommodation space 62 connects with the inflow channel 61 on one end side. The first accommodation space 62 connects with the second accommodation space 63 on the other end side. The first accommodation space 62 takes in the external operating fluid from the inflow channel 61. The first accommodation space 62 is an interior space formed in the casing 6B which rotatably accommodates the second impeller 51 of the centrifugal separator 5B.

The foreign substance expulsion channel 64B is attached to the center part of the first accommodation space 62 in the axial direction. The foreign substance expulsion channel 64B is disposed in one location (the upper side on the paper surface) in the circumferential direction around the axis O. The foreign substance expulsion channel 64B forms a hole shape, and the channel cross section has the same cross section from its inlet to its outlet.

The foreign substance collection chamber 65B is formed in the casing 6B. The foreign substance collection chamber 65B extends over the entire periphery along the circumferential direction around the axis O. The foreign substance collection chamber 65B has connected thereto the end part on the downstream side of the foreign substance expulsion channel 64B.

The centrifugal separator 5B is provided with a protruding part 53 and a protruding part 54, which protrude toward both sides in the direction of the axis O from a base 52, on the rotation shaft 21A side. The protruding part 53 and the protruding part 54 are provided in a flange shape over the entire periphery of the circumferential direction. Of the protruding parts, the first protruding part 53 is pressed from the outer peripheral side by the holding recessed part 21b provided on the rotation shaft 21A. The other, the second protruding part 54, is pressed from the outer peripheral side by a fitting nut 7 (fitting member) which is attachable and removable relative to the rotation shaft 21A.

Here, the rotation shaft 21A of the shaft 21 is formed with a smaller diameter than the other portions of the shaft 21 (the holding part 21B illustrated in FIG. 10). A ridge is formed on the connecting portion between the rotation shaft 21A and the holding part 21B. The holding recessed part 21b opens toward the upstream side (toward the centrifugal separator 5B side) in the direction of the axis O on this ridge. The holding recessed part 21b is formed over the entire periphery of the circumferential direction.

The fitting nut 7 is provided with a female screw 71 and a fitting recessed part 72. The female screw 71 is provided on the same axis as the rotation shaft 21A. The female screw 71 is formed on the outer peripheral surface of the rotation shaft 21A. The fitting recessed part 72 fits from the outer peripheral side relative to the second protruding part 54. When rotated around the axis O and tightened, the fitting nut 7 moves from the upstream side to the downstream side in the direction of the arrow E1, and is made so the fitting recessed part 72 fits on the outer peripheral side of the second protruding part 54 of the centrifugal separator 5B.

An inner peripheral surface 72a of the fitting recessed part 72 forms a tapered surface. The tapered surface progressively expands radially outward from the upstream side to the downstream side. By having a taper surface in this manner, the inner peripheral surface 72a of the fitting recessed part 72 fits with the outer peripheral surface 54a of the second protruding part 54 in a state of being in close contact.

The operation of the attachment structure for a centrifugal separator with the configuration described above is described in detail next, with reference to drawings.

As illustrated in FIG. 10, according to the attachment structure for the centrifugal separator 5B, the centrifugal separator 5B is attached to the rotation shaft 21A. At this time, the first protruding part 53 and the second protruding part 54 which protrude on both sides in the direction of the axis O from the base 52 of the centrifugal separator 5B are in a state such that they are pressed down by the holding part 21B of the shaft 21 and the fitting nut 7, respectively, from the outer peripheral side. In other words, the base 52 of the centrifugal separator 5B is pressed in the direction opposite the centrifugal force acting radially outward. As a result, the resistance against the centrifugal force is increased.

The fitting nut 7 which presses, the other, the second protruding part 54, from the outer peripheral side is attachable and removable relative to the rotation shaft 21A. Because of this, the fitting of the fitting nut 7 relative to the rotation shaft 21A can be freed by moving the fitting nut 7 toward the upstream side (in the direction of the arrow E2) by rotating in the direction the screw loosens (in the direction of the arrow E2). This allows the pressing on the second protruding part 54 to be released, and the centrifugal separator 5B to be easily separated from the rotation shaft 21A.

In this manner, it becomes possible to improve the work efficiency for attaching and removing the centrifugal separator 5B. Because of this, it is possible to efficiently exchange or perform maintenance such as cleaning for the centrifugal separator 5B.

With the attachment structure for a centrifugal separator according to the third embodiment described above, by simply performing the attachment and removal work, work efficiency can be improved, and furthermore, resistance against the centrifugal force can be improved.

An embodiment of an attachment structure for a centrifugal separator according to the present invention has been described but the present invention is not limited to the aforementioned third embodiment, and may be changed as appropriate in a range that does not deviate from the main intent thereof.

For example, in the third embodiment, the holding part provided as one body on the rotation shaft 21A is the target of the holding part 21B, which is a part of the shaft 21. However, the holding part is not limited to being these parts. For example, the holding part may be the rotor 31, acting as the holding part provided as one body on the rotation shaft 21A. In this case, the first protruding part 53 can be pressed on its entire periphery by the rotor 31, which can secure stability and high strength.

In the third embodiment, the position at which the fitting member (fitting nut 7) fits is on the upstream side of the centrifugal separator 5B, in the direction of the axis O. However, the protruding part on the downstream side may be pressed and fitted from the outer peripheral side by the fitting member, and the protruding part on the upstream side may be pressed by a holding part provided as one body on the rotation shaft 21A.

The centrifugal separator 5B may be divided in the circumferential direction. In this case, by freeing the fitting of the fitting member relative to the second protruding part 54, the centrifugal separator 5B, which has been divided in the circumferential direction, can be removed from the rotation shaft 21A. In other words, the centrifugal separator 5B can be exchanged without performing the work to release the rotor 31 connected to the rotation shaft 21A from the shaft 21. In particular, when the fitting member is a nut-style fitting nut 7 as described above, the work to completely remove the fitting member from the rotation shaft becomes unnecessary.

As for the fitting member, it is not limited to the shape nor dimensions of the fitting nut 7 such as that of the present embodiment, but other shapes and modes may be utilized.

Configurations such as the shape, size, position, and quantity for the centrifugal separator 5B, the foreign substance expulsion channel 64B, the foreign substance collection chamber 65B, and the like may be set as appropriate.

On the other hand, within a range that does not deviate from the intent of the present invention, the constituent elements of the embodiments described above may be replaced as appropriate with known constituent elements, and the embodiments described above may be combined as appropriate.

### INDUSTRIAL APPLICABILITY

According to the compressor system described above, mixing of foreign substance into an impeller can be mitigated, and damage to the impeller can be prevented by efficiently separating foreign substances in a fluid.

According to the attachment structure for a centrifugal separator described above, by simply performing attachment and removal work, work efficiency can be improved, and furthermore, resistance against the centrifugal force can be improved.

### REFERENCE SIGNS LIST

1 Compressor system
O Shaft line
2 Compressor
21 Shaft
21A Rotation shaft
21B Holding part
21b Recessed holding part
21c Male screw
22 First impeller
23 Housing
3 Motor
31 Rotor
32 Stator
33 Gap
4 Bearing
41 Journal bearing
42 Thrust bearing
5, 5A, 5B Centrifugal separator
51 Second impeller
52 Base
53 First protruding part
54 Second protruding part
6, 6A, 6 Casing
60 Sealing member
61 Inflow channel
62 First accommodation space
63 Second accommodation space
64, 64A, 64B Foreign substance expulsion channel
65, 65A, 65B Foreign substance collection chamber
T Pressure region
7 Fitting nut
71 Female screw
72 Fitting recessed part

1. A compressor system, comprising:
a drive part;
an impeller for pressure-feeding a fluid radially outward after the fluid has flowed in from an axial direction by rotating around the shaft line via the drive part;
a centrifugal separator provided on the upstream side of the impeller and formed to be larger than the outer diameter of the inlet of the impeller, which feeds the externally supplied fluid out toward the impeller while causing the fluid to swirl by rotating around the shaft line via the drive part: and
a casing for sectioning off an inflow channel which guides the fluid from the exterior to the centrifugal separator, a first accommodation space which is disposed downstream from the inflow channel and which accommodates the centrifugal separator, a second accommodation space which is connected to the downstream side of the first accommodation space and which accommodates the impeller, and a foreign substance expulsion channel which is connected downstream of the first accommodation space in the axial direction and expels foreign substances guided to the outer peripheral side by the centrifugal separator.

2. The compressor system according to claim 1, wherein the foreign substance expulsion channel extends from the first accommodation space in the axial direction to the impeller side, and outward in the radial direction.

3. The compressor system according to claim 1, wherein the casing sections off a foreign substance collection chamber which connects to the foreign substance expulsion channel.

4. The compressor system according to claim 1, wherein the diameter of the channel cross section of the foreign substance expulsion channel progressively gets smaller from the upstream side to the downstream side.

5. A compressor system, comprising:
a drive part;
an impeller for pressure-feeding a fluid radially outward after the fluid has flowed in from an axial direction by rotating around the shaft line via the drive part;
a centrifugal separator provided on the upstream side of the impeller, which feeds the externally supplied fluid out toward the impeller while causing the fluid to swirl by rotating around the shaft line via the drive part; and
a casing for sectioning off an inflow channel which guides the fluid from the exterior to the centrifugal separator, a first accommodation space which is disposed downstream from the inflow channel and which accommodates the centrifugal separator, a second accommodation space which is connected to the downstream side of the first accommodation space and which accommodates the impeller, and a foreign substance expulsion channel which extends radially outward from the first accommodation space and expels foreign substances guided to the outer peripheral side by the centrifugal separator.

6. The compressor system according to claim 5, wherein the casing connects to the foreign substance expulsion channel, and sections off a foreign substance collection chamber which extends over the entire periphery along the circumferential direction around the shaft line.

7. The compressor system according to claim 5, wherein a plurality of foreign substance expulsion channels are provided in the circumferential direction around the shaft line, such that
the foreign substance expulsion channels are disposed in a pressure region which causes the pressure of the fluid in the circumferential direction of the first accommodation space to be equal.

8. The compressor system according to claim 5, wherein a plurality of foreign substance expulsion channels are provided along the axial direction of the first accommodation space.

9. An attachment structure for a centrifugal separator provided on the upstream side of an impeller which pressure-feeds a fluid radially outward after the fluid has flowed in from an axial direction by rotating around the shaft line via the drive part, and feeds the externally supplied fluid out toward the impeller while causing the fluid to swirl by rotating around a rotation shaft on the same shaft as the shaft line via the drive part,
the centrifugal separator has two protruding parts provided thereon which protrude toward both sides in the axial direction from a base of the rotation shaft side,
a first protruding part, of the two protruding parts, is pressed from the outer peripheral side by a holding recessed part provided on a holding part provided as one body on the rotation shaft, and
a second protruding part is pressed from the outer peripheral side by a fitting member which can be attached and removed relative to the rotation shaft.

10. The attachment structure for a centrifugal separator according to claim 9, wherein the fitting member is provided with
a female screw which is provided on the same shaft as the rotation shaft and screws into the outer peripheral surface of the rotation shaft, and
a fitting recessed part, which fits from the outer peripheral side relative to the second protruding part.

11. The attachment structure for a centrifugal separator according to claim 9, wherein the centrifugal separator is divided in the circumferential direction.

12. The compressor system according to claim 2, wherein the casing sections off a foreign substance collection chamber which connects to the foreign substance expulsion channel.

13. The compressor system according to claim 2, wherein the diameter of the channel cross section of the foreign substance expulsion channel progressively gets smaller from the upstream side to the downstream side.

14. The compressor system according to claim 3, wherein the diameter of the channel cross section of the foreign substance expulsion channel progressively gets smaller from the upstream side to the downstream side.

15. The compressor system according to claim 6, wherein a plurality of foreign substance expulsion channels are provided in the circumferential direction around the shaft line, such that
the foreign substance expulsion channels are disposed in a pressure region which causes the pressure of the fluid in the circumferential direction of the first accommodation space to be equal.

16. The compressor system according to claim 6, wherein a plurality of foreign substance expulsion channels are provided along the axial direction of the first accommodation space.

17. The compressor system according to claim 7, wherein a plurality of foreign substance expulsion channels are provided along the axial direction of the first accommodation space.

18. The attachment structure for a centrifugal separator according to claim 10, wherein the centrifugal separator is divided in the circumferential direction.
